(19) United States
(12) Patent Application Publication
(10) Pub. No.: US 2001/0040587 A1
(43) Pub. Date: Nov. 15, 2001

(54) TOUCH CONTROL OF CURSONR POSITION

(76) Inventor: E. J. SCHECK, BEAVERTON, OR (US)

Correspondence Address: FRANCIS I. GRAY, TEKTRONIX, INC., DELIVERY STATION 63-LAW, P.O. BOX 1000, WILSONVILLE, OR, 970701000

(21) Appl. No.: 08/151,646

(22) Filed: Nov. 15, 1993

(51) Int. Cl. G09G 5/00

(52) U.S. Cl. 345/676

(57) ABSTRACT

A method of touch control of cursor position for a display device having a touch sensitive screen determines, upon contact of the screen by a pointer, whether cursor data exists within a display memory at addresses related to the contact point. If cursor data exists, a cursor mode is initiated so that all movement of the pointer across the touch sensitive screen results in the cursor apparently moving with the pointer on the display device. Once contact is broken with the touch sensitive screen, the cursor mode is controlled conventionally with a knob.

### BACKGROUND OF THE INVENTION

The present invention relates to cursors for waveform/graphics displays, and more particularly to touch control of cursor position for a display device using a touch sensitive display screen.

Currently cursors are positioned on displays by using buttons and knobs at a control panel. In this manner a cursor, which is a pointer to a particular point on a display identifying a feature of interest, may be moved to any point on the display screen. For waveform display devices this means that the cursor may be positioned at a particular point on a waveform so that certain information about that point, such as magnitude, or in reference to that point, such as duration, may be determined.

Touch screens are commonly used in display devices to select items from a menu displayed on the screen, or to select a region of a display for further processing. An example of further processing is a zoom function which may be implemented about a contact point on a touch screen, as disclosed in U.S. Pat. No. 4,755,811 issued Jul. 5, 1988 to Keith R. Slavin entitled “Touch Controlled Zoom of Waveform Displays” and incorporated in the VM700 Video Measurement Set manufactured by Tektronix, Inc. of Wilsonville, Oreg., United States of America.

What is desired is touch control of cursor positions so that an operator may interact intuitively with the display without the need for using buttons and knobs.

### SUMMARY OF THE INVENTION

Accordingly the present invention provides a method for touch control of cursor position for a display device using a touch sensitive screen. With a cursor being displayed on a display screen, an operator touches the screen at the current position of the cursor with an appropriate pointer, such as a finger. Contact with the screen initiates a search to determine what is at the contact point on the display within a tolerance range. If the cursor is determined to be at the point of contact, then the display device enters a cursor mode so that further activities are related to the cursor. As the pointer is dragged across the screen, the position of the cursor is recalculated to remain underneath the pointer so that the cursor appears to move with the pointer. In this manner the cursor position is controlled by touching the screen. When the pointer breaks contact with the screen, further movement of the cursor in the cursor mode made be made conventionally with a knob.

The objects, advantages and other novel features of the present invention are apparent from the following detailed description when read in conjunction with the appended claims and attached drawing.

### BRIEF DESCRIPTION OF THE DRAWING

FIG. 1 is a block diagram of a display device that uses touch control of cursor position according to the present invention.

FIGS. 2A and 2B illustrate the operation of touch control of cursor position according to the present invention.

FIG. 3 is a flow chart for the touch control of cursor position according to the present invention.

### DESCRIPTION OF THE PREFERRED EMBODIMENT

Referring now to FIG. 1 a test instrument 10 is shown of the type for acquiring and displaying waveform characteristics of an input electrical signal. However any display device, including graphics display devices, may use the touch control of cursor position as disclosed herein. An acquisition system 12 receives an analog signal and converts it to a digital signal for storage in an acquisition memory 14. For signals that are already in digital form, such as graphics images, the signals may be input directly into the acquisition memory 14. A display processor 16 has a bus 18 to which the acquisition memory 14 is coupled. The display processor 16 includes a processor unit 20 and a program memory 22. The display processor 16 processes the data in the acquisition memory 14 and stores the processed data in a display memory 24. The data from the display memory is then displayed by the display processor 16 on a screen 26. An operator interacts with the display processor 16 via an appropriate interface 28, such as a keyboard, mouse, touch screen on the screen 26, controls on a front panel 30, or the like. The display processor 16 provides a cursor 32 for the display in the form of either a vertical or horizontal line or other appropriate icon, as is well known in the art. The cursor 32 is stored with the acquired data in the display memory 24. The initial position of the cursor 32 may be at the center of the screen 26, or at the upper left hand corner of the screen, or other predetermined position.

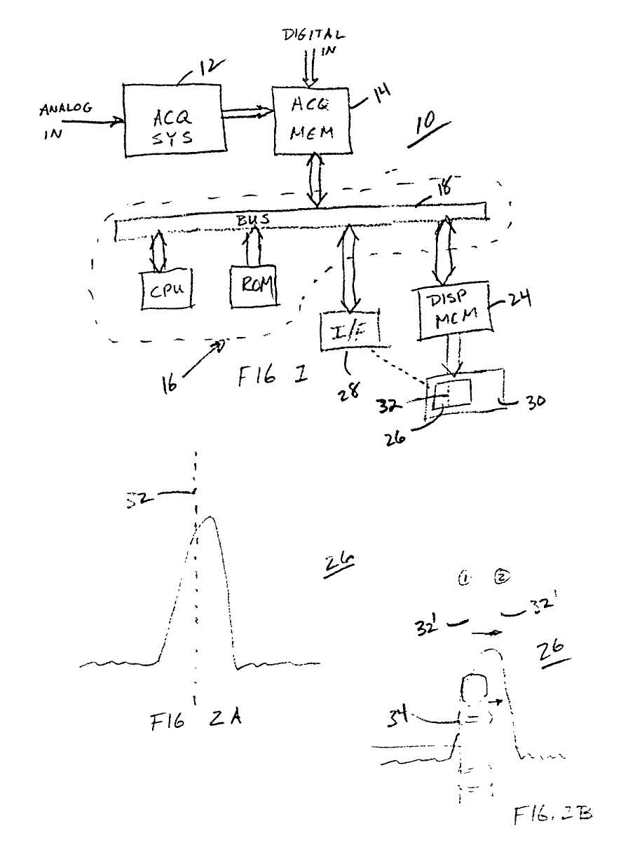

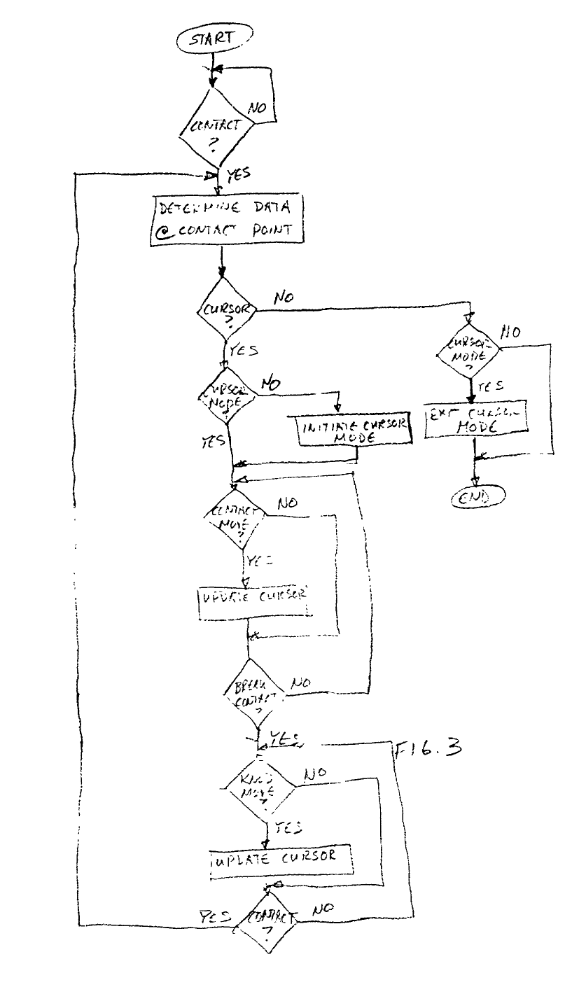

To move the cursor position on the display, an operator touches the screen 26 at the current cursor position (1) with an appropriate pointer 34, such as a finger shown in FIG. 2b. Contact with the screen 26 initiates a search procedure that uses the coordinates of the contact point. The display processor 16 compares the contact point with the current position of the cursor 32, which is maintained in the display processor. If the current cursor position corresponds to the contact point, then a cursor mode is initiated. The initiation of the cursor mode may be indicated on the screen by a change in the representation of the cursor 32′ by the display processor 16, such as changing the representation from a dotted line to a solid line or a flashing cursor icon to a steady icon.

Once the cursor mode is initiated, which includes assigning a control knob to the cursor 32′, all further movement of the point of contact by the pointer 34 is processed by the display processor 16 as affecting the position of the cursor on the display as if it were the control knob that was being rotated. The display processor 16 updates the cursor data in the display memory 24 by rewriting it in a new position corresponding to the new contact point (2) of the pointer 34 on the screen 26 when the display memory is updated from the acquisition memory 14. The cursor mode may be combined with the zoom mode, described in the aforementioned U.S. Pat. No. 4,755,811, so that zoom occurs about the current contact point and the cursor is positioned closer to the point of interest as zoom occurs. Once contact is broken with the screen 26, further movement of the cursor 32 may be controlled conventionally by the control knob.

Thus the present invention provides touch control of cursor position by determining whether a contact point on a display screen coincides with a current cursor position, and then updating the cursor position as the contact point moves across the display screen.

What is claimed is:

1. A method of touch control of cursor position on a display device having a touch sensitive screen comprising the steps of:
determining from an initial contact point by a pointer on the touch sensitive screen whether a cursor is positioned at the initial contact point; and
updating the cursor position, as the pointer moves from the initial contact point in contact across the touch sensitive screen, to correspond to an instantaneous point of contact during the movement so that the cursor appears to move on the display device with the pointer.

2. The method as recited in claim 1 wherein the determining step comprises the steps of:
determining whether the pointer is in contact with the touch sensitive screen;
identifying the contact point as the initial contact point and converting the initial contact point to a cursor position datum; and
comparing the cursor position datum with a current known cursor position to determine whether the initial position includes the cursor.

3. The method as recited in claim 2 wherein the updating step comprises the steps of:
determining whether the pointer has moved to a new contact point on the touch sensitive screen;
identifying cursor addresses for the display memory based upon the new contact point;
writing the cursor into the cursor addresses for the new contact point when the display memory is updated; and
repeating the determining, identifying and writing steps immediately above, with the new contact point becoming the initial contact point, so long as the pointer is in contact with the touch sensitive screen.
